(19) United States
(12) Patent Application Publication
(10) Pub. No.: US 2009/0305606 A1
(43) Pub. Date: Dec. 10, 2009

(54) Material and method for creating a play environment

(76) Inventor: Ronald David Coben, Houston, TX (US)

Correspondence Address: SHAPER ILER LLP, 1800 WEST LOOP SOUTH, SUITE 1450, HOUSTON, TX, 77027, US

(21) Appl. No.: 12/291,218

(22) Filed: Nov. 7, 2008

Related U.S. Application Data
(63) Continuation-in-part of application No. 12/136,699, filed on Jun. 10, 2008.

(51) Int. Cl. A63H 33/30; B32B 5/00; B32B 37/00

(52) U.S. Cl. 446/478; 428/352; 156/71

(57) ABSTRACT

Material for providing a play environment for a play figure including a non-scar, quick-release adhesive roll of material having a play environment decor, and optionally including three-dimensional toy units and/or a kit comprising the material packaged together with at least one toy unit.

The instant invention is related to, claims priority to, and comprises a continuation-in-part of the instant inventor's co-pending application entitled “An Apparatus and Method for a Rolled Roadway,” Ser. No. 12/136,699, inventor Ron Coben, filed Jun. 10, 2008. The contents of said “An Apparatus and Method for a Rolled Roadway,” Ser. No. 12/136,699, are hereby incorporated herein by reference in their entirety.

### FIELD OF THE INVENTION

The invention relates to material and method for enhancing a playing environment, and particularly includes a non-scar, quick-release adhesive roll of material (or strips of material or pieces of material as defined herein) displaying a play environment structure.

### BACKGROUND OF THE INVENTION

Applicant has invented a cost-effective visually pleasing, child friendly system and method to create a play environment and to enhance the value of toys. The particular toy units in mind include cars, trucks, airplanes, fantasy vehicles, dolls, plush toys, and animal and action and fantasy figures. The creation of an enhanced play environment is effected by means of a “roll of adhesive material” (defined more broadly below) displaying play environment structure and coordinated with particular toy units. Portions of the material are separated from the roll and applied to domestic substrate, such as domestic flooring, walls, woodwork and furniture and the like. Thereby, an exciting environment is created for playing with cars, trucks, planes, action figures, human figures, animal figures and fantasy figures. The non-scarring quick release adhesive material can be quickly removed from the domestic substrate without damage to the substrate or residue on the substrate, and can be thrown away. Movie, video game or TV scenes can be reenacted. Popular board games can be re-created, in whole or in part, or can be expanded.

In preferred embodiments, portions of the material, such as strip portions, can contain pleated or ribbed or corrugated or spliced areas enabling the portion to be curved, by straightening the pleats or corrugations or connecting the spliced areas, upon application to a substrate.

### SUMMARY OF THE INVENTION

The instant invention discloses the use of pre-printed, quick-release “rolls of adhesive tape or material” for creating, simulating and/or enhancing temporary or semi-permanent play areas, by depicting suitable play area structure, suitable for coordination with miniature vehicles, dolls, doll houses, toy buildings, plush toys, board games or other toys. The structure graphically includes but is not limited to:
décor, cabinetry, appliances, electronics, rugs, flooring, wall coverings, fashion show runway, wainscoting, signage, furniture, holiday decorations, concession stands, people, animals, crowds and other visual stimuli normally found inside a residential, commercial, industrial or recreational structure located on any known planet, moon, star or fantasy setting either in the past, present or future;
driveways, sidewalks, paths, gardens, landscaping, trees, grass, dirt, ponds, golf courses, swing sets, wood siding, brick, stone, fencing, holiday decorations, smokestacks, people, animals, crowds, vehicles and other visual stimuli normally found external to a residential, commercial, industrial or recreational structure located on any known planet, moon star or fantasy setting either in the past, present or future;
mountains, waterfalls, buildings, skylines, street lights, telephone poles, traffic lights, traffic signs, bus stops, traffic, street scenes, pets, animals, bird formations, clouds, weather, crowd scenes, people, vehicles and other visual stimuli normally found in any size rural or urban area, community, town or city located on any known planet, moon star or fantasy setting either in the past, present or future;
spaces used for movements of player tokens during the play of board games; (the order of such spaces can be random resulting in a different play of a game each time depending on where a roll of adhesive material was cut the last time, the amount of overlap and intersection used by the person applying the material to the substrate, the pattern with which the person applies the strip of material and the length of the path used by the person applying the material; thus, each occurrence of play could be very different from the prior play creating additional interest and excitement and avoiding boredom of the players;)
representation in miniature of sporting play areas and fields including but not limited to golf courses with tee-boxes, fairways and greens, bowling alleys, football fields, soccer fields, basketball courts and shuffleboard that users utilize by sliding, projecting, rolling or otherwise moving objects to simulate actual or fantasy play along a course that can be laid out differently each time by the user;
interior of castles, spaceships and fantasy structures;
scenes from movies, TV shows/DVD's and video games;
seasonal scenes, such as Santa Claus, Easter Bunny, Halloween.

### BRIEF DESCRIPTION OF THE DRAWINGS

A better understanding of the present invention can be obtained when the following detailed description of the preferred embodiments are considered in conjunction with the following drawings, in which:

FIGS. 1A-1G illustrate multiple forms in which a “roll” of the instant “material” might be provided, which could be similar to a roll of tape, a roll of wallpaper, a box of tissues, a packet of wipes, a canister of wipes and/or a stack of post-it sheets, all of which are methods of presenting sequenced portions of material and are referred to herein as a “roll.”

FIGS. 2A-2D illustrate sheet shaped portions of roll material adhered in a room, on a wall, and on a floor, to create a play environment.

FIGS. 3A-3C illustrate how portions of material with adhesive along one edge can create a freestanding play area either alone or in conjunction with other materials affixed to floors, walls or other toys, as stand-up portions, and how said portions can curve.

FIGS. 4A-H illustrates examples of removable “roadway” related tape.

The drawings are primarily illustrative. It would be understood that structure may have been simplified and details omitted in order to convey certain aspects of the invention. Scale may be sacrificed to clarity.

### DETAILED DESCRIPTION OF THE PREFERRED EMBODIMENTS

Illustrative play environment structure can include a roadway, a parking way, a waterway, a plane runway, a fashion model runway, a fence, an interior structural wall or area with related units, an exterior wall or structure with related units, a scenic view, a farm yard, a sports field, a mall, a parking lot, a school field, a play field, a mythical space or structure, a battlefield, the interior of a spaceship and the exterior of a spaceship.

A related play environment unit or figure or toy can include a car, a truck, a boat, a plane, a doll, an action figure, a hero figure, a human figure, an animal figure, a mythical figure, a movie or TV figure or a board game marker.

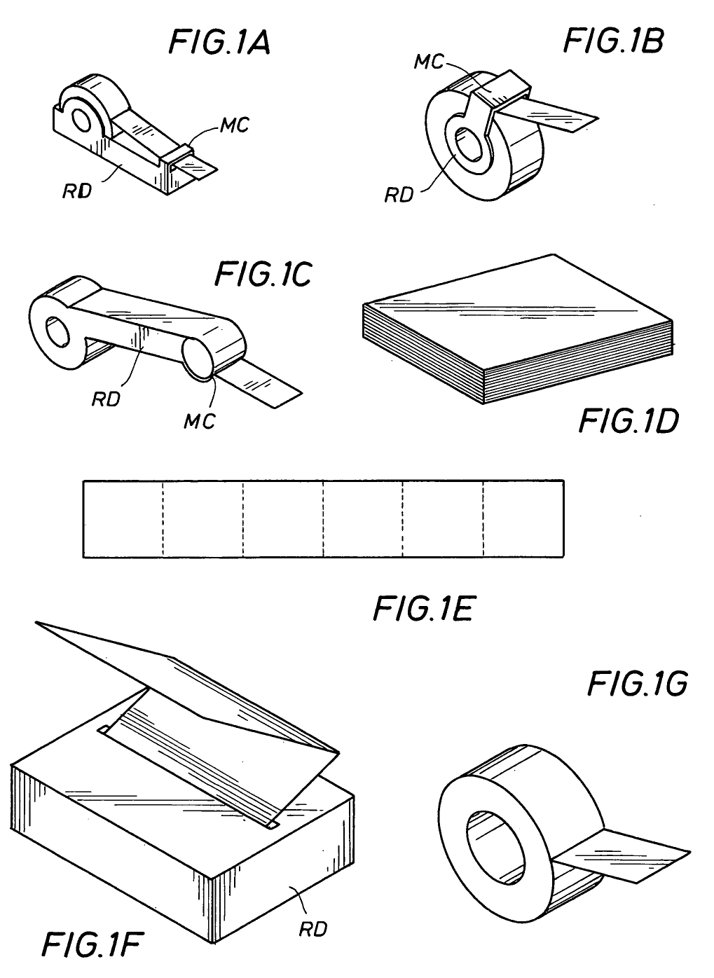

In preferred embodiments a roll of material may also include a roll container or dispenser and means for cutting or tearing the roll of material, or for separating portions of the roll. FIGS. 1A-1F illustrate roll containers or dispensers RD and means for cutting or separating out portions of roll material, MC.

In preferred embodiments a “roll of material” might resemble a roll of tape, including a wide roll of tape. However, separate or loosely attached sheets might be folded, interleaved or rolled together to form a “roll of material.” A “roll of material” should be understood to include a length of material folded again back on itself. Tissue in a tissue box or wipes in a wipe package or a roll of stamps are intended to be regarded as a roll of material. The roll of material could take the form of a pad of post-it notes which could be removed in sequence. The understanding would be, again, that the pad of sheets would have adhesive applied such that the sheet would substantially adhere to a substrate. See FIGS. 1A-1G. FIG. 1G represents a roll of material or tape without any cutting device on tape.

Play environment units could also include a minimally 3D set of stickers that are removed from a substrate and utilized in combination with a suitable play environment decor, especially when simulating a movie or video game or TV scenario.

The non-scar and quick-release features of the adhesive are important to ensure that the material may be easily removed from floors, woodwork, table tops carpets, fabrics, concrete and other domestic substances without scar, mar, stain or residue.

The adhesive can be applied to the roll solidly or could be applied in stripes, dots, cross-hatching or crisscrossing. The essential feature of the adhesive is that a roll portion substantially adheres to a floor or wall or tabletop, including in particular at one or more edges and corners, to facilitate trouble-free use, as it is designed for use.

Preferably the adhesive is a solvent-based, removable, pressure sensitive adhesive (such as an “acrylic”) which has a low peel value (defined as the number of ounces per inch required to break the adhesive bond). For some embodiments the adhesive may utilize the “Post-It note adhesive technology,” patent filed Mar. 9, 1970, U.S. Pat. No. 3,691,140, issued Sep. 12, 1972.

The adhesive is to be applied to the material and the material to be self-wound or stacked or folded into a “roll”. The material with adhesive and printed graphics of structure is preferably wound onto a core. Users then can simply pull the free end of the substrate and the material preferably releases from itself and is ready to stick on another surface. The non-adhesive portion of the material may be treated with what is commonly called a “release coat” so that the material more easily releases from itself and unwinds.

“Stickers” are pressure sensitive adhesives affixed to a liner. A consumer peels a sticker from the surface of a liner. It is possible to selfwind stickers on liners in which case no release coat would be needed but the liner is left behind to be discarded. Preferably the instant material is self-wound on a core without a liner so that it appears and functions as a typical roll of tape. In a less preferred embodiment the material is self wound as tape on a liner.

Options for dispensing include no dispenser, because the product may be used directly by children. Preferably the product is designed to be suitably thin and of a material that can be easily hand torn or cut with child or adult scissors.

The product may also have perforations running the width of the tape at various intervals along the roll to facilitate straighter hand-tearing. The product may come with an un-honed, non-serrated straight-edge which affixes to the roll and sits along the outermost surface of the roll to provide a non-sharp edge upon which the tape may be torn straight.

The product may provide a dispenser which holds the core of the roll allowing it to freely spin and provides a serrated cutting edge to cut the tape and a small surface with which to adhere the leading edge of the tape away from the roll itself thereby making it ready for the next use.

The product may provide a hand-held applicator/dispenser which holds the leading edge of the material away from the roll itself and exposes some or all of the leading edge whereby it can be touched and adhered directly to a surface, freely rolled, and cut with a straight-edge or serrated edge on the “gun” all with one hand movement.

A container or supporting device without sides or with limited sides could hold a stack or pad of pre-cut lengths of product that can be peeled off one at a time. This embodiment works best if the entire back of the tape is not coated with adhesive but if adhesive is on one-edge of the material.

A container with an opening on the top surface which holds pre-cut lengths of the product stacked accordion style to allow quick, “pop-up” access may be provided. This embodiment works best if the entire back of the tape is not coated with adhesive, but if adhesive is on only one edge of the substrate.

### Product Variations

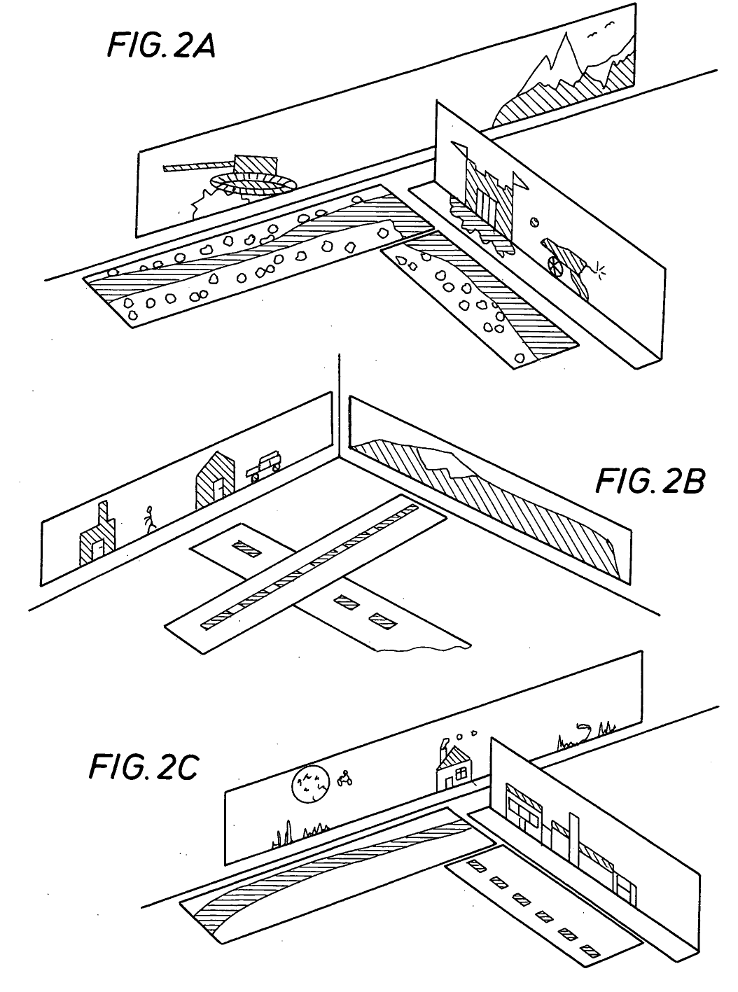

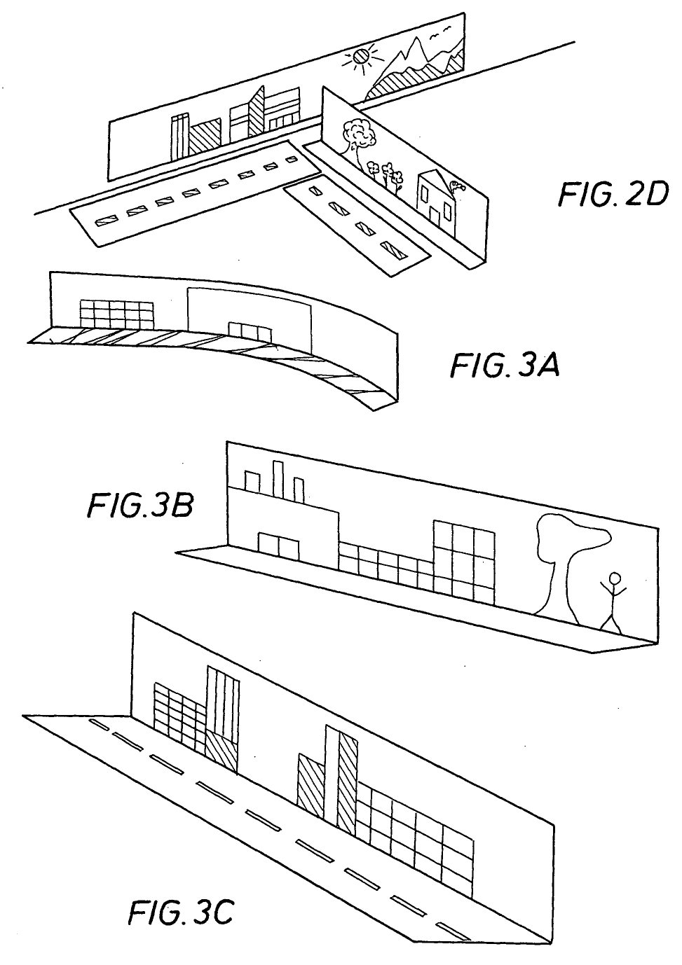

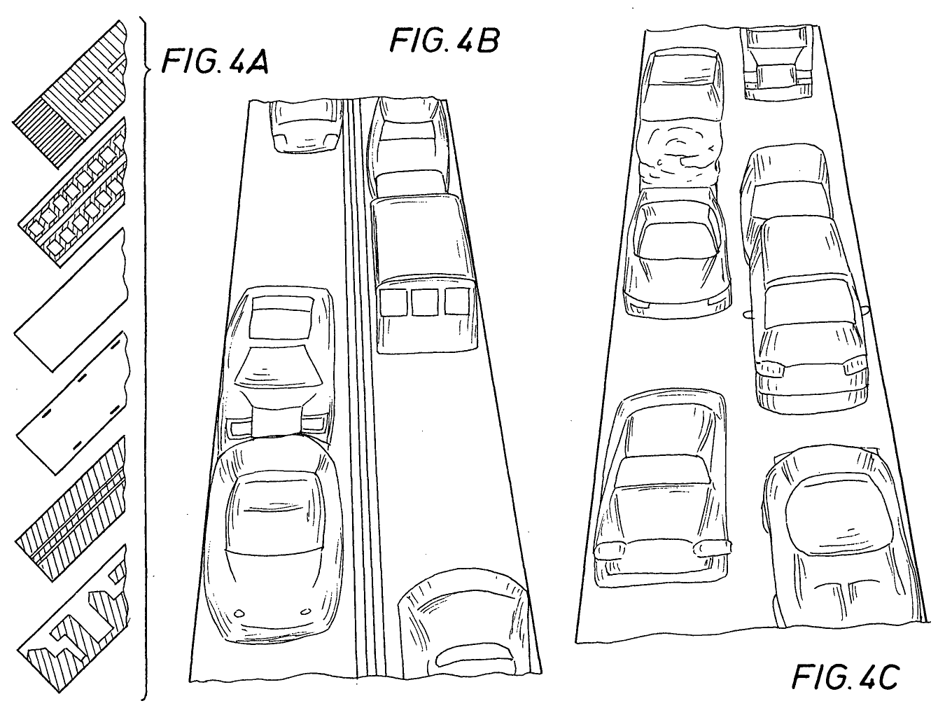

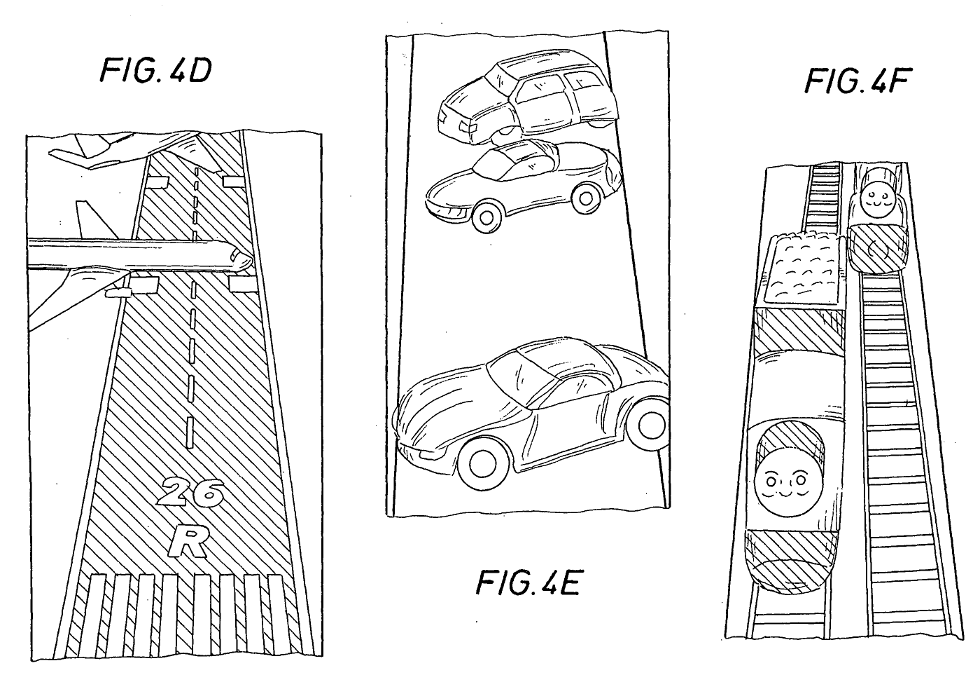

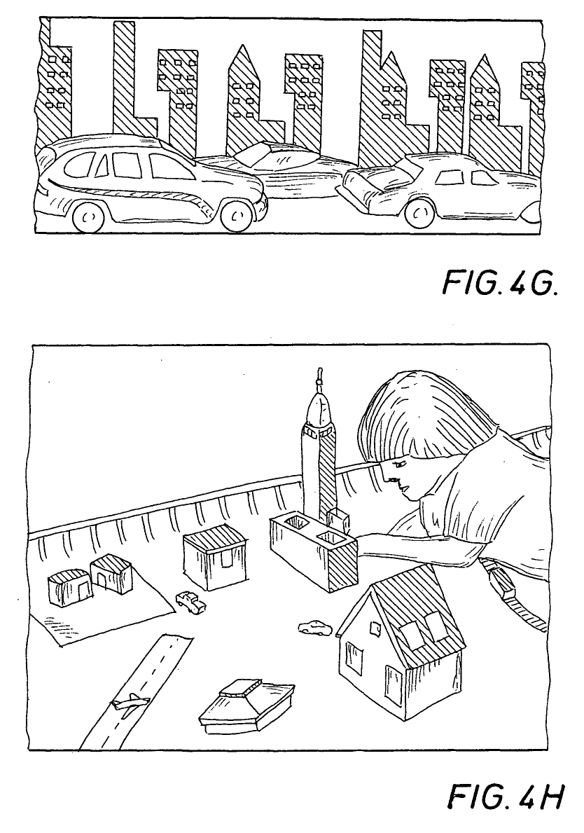

FIGS. 2A-D and 3A-3C illustrate stand-up scenery/structures/figures/thing. A material with adhesive along one edge or side and no adhesive along the other edge or side can be provided such that when a length of the tape is torn, cut or perforated from the roll, the adhesive edge is placed on a surface and the tape may be creased to create an approximate right angle. The non-adhesive portion of the tape preferably stands at an approximate 90 degree angle from either a horizontal or vertical surface creating a three-dimensional play surface or accessory from an otherwise flat piece of tape. Example structures include: scale versions of skylines, storefronts, cityscapes, structures (four pieces placed at right angles create a four-sided building), people, characters, animals, patterns, etc. This style of product in short lengths lends itself to the pop-up style dispenser, for example, a pop-up box of building sides to create buildings of various polygonal shapes, a pop-up box of street signs, a pop-up box (perhaps the size of a roll of Saran Wrap) of street scenes or skylines, etc.

FIG. 3A illustrates a curved stand-up scenery/structures/figures/thing, which is the same as above except the edge of the tape with the adhesive has partial cuts (or perforations that can be torn or corrugation that can be smoothed out) which allows a user to slightly overlap the adhesive pieces as they are adhered to the surface creating a curved substrate which stands up approximately perpendicular to the base surface. FIG. 3C gives an illustration of how freestanding scenery could also be printed on the edge which is adhered to the substrate. In the attached drawing, a roadway is printed on the surface of the edge with adhesive and a skyline on the edge which is folded upright. Tape or material can be creased or scored to facilitate bending.

Die-cut accessory pieces can be included with the invention. Utilizing the same adhesive, one can create die-cut accessory pieces on liners to be peeled off and used in conjunction with the core product offering and to facilitate connections, directional changes, areas of interest, etc. Examples include: intersections, roundabouts, curves, etc.

Use of special inks on the printed side of the material or in combination with printing on both sides of the material tape allows for the graphic representation of one scene or object which then changes when the light source in the room changes. For example, a tape printed with blue sky, clouds and the sun would disappear when the lights in the room are turned off and a glow-in-the-dark night sky, moon, and stars would appear. Or a sunny, daytime skyscraper skyline would have yellow windows, red airplane warning lights and a moon appear when room lights are dimmed.

Use of a draw your own tape is envisioned. This includes an uncoated, writable substrate that allows users to create their own scenes, characters, vignettes, objects, etc. and position their own art or creations within their work or play area.

Tables 1 and 2 summarize facts related to, and illustrate the present need for, the invention. Table 3 illustrates criteria for the invention, and objectives. Table 4 lists benefits of the invention.

The foregoing description of preferred embodiments of the invention is presented for purposes of illustration and description, and is not intended to be exhaustive or to limit the invention to the precise form or embodiment disclosed. The description was selected to best explain the principles of the invention and their practical application to enable others skilled in the art to best utilize the invention in various embodiments. Various modifications as are best suited to the particular use are contemplated. It is intended that the scope of the invention is not to be limited by the specification, but to be defined by the claims set forth below. Since the foregoing disclosure and description of the invention are illustrative and explanatory thereof, various changes in the size, shape, and materials, as well as in the details of the illustrated device may be made without departing from the spirit of the invention. The invention is claimed using terminology that depends upon a historic presumption that recitation of a single element covers one or more, and recitation of two elements covers two or more, and the like. Also, the drawings and illustration herein have not necessarily been produced to scale.

TABLE 1
THE NEED

```
Boys love toy vehicles
    94% of boys age 3-9 regularly play with toy vehicles including
    Hot Wheels ®,
    Matchbox ®, Thomas the Tank Engine ®, and diecast airplanes
    Mattel reports Hot Wheels ® & Matchbox ® domestic revenue
    of $250-$300 million plus $600-$700 million more internationally
Boys prefer “hand-rolling” toy vehicles to “propelling” vehicles
    57% usually hand-roll vs. 42% usually propel the vehicles
Tracks/sets/kits under-penetrate boys who play with toy vehicles
    89% own Hot Wheels ® vehicles; only 49% own Hot
    Wheels ® track & sets
    69% own Matchbox ® vehicles; only 25% own Matchbox ®
    tracks & sets
    54% own Thomas ® trains; only 33% own Thomas ® track
    43% own toy airplanes; only 9% own runways or airports
    53% own a cityscape play mat
```

TABLE 2
Nationwide Study Proves
Road Play ™ Popularity Rivals
Hot Wheels ®, Lego ® & Matchbox ®

```
In a nationwide survey of parents whose children age 3-9 play with toy
vehicles during most of their playtime, 75% stated they would buy Road
Play ™ once the product is brought to market (19% of the
respondents “might” buy; only 6% said they would “not
buy” it). These parents indicated they would buy nearly four rolls of
Road Play ™ annually. 71% viewed the $7.99 price point as
“about right,” four in ten respondents would be willing to pay more
than $7.99 with 23% willing to pay up to $10.99.
Impressively, the survey also showed toy ownership patterns for these
same families and how Road Play's purchase intent would compare:
    90% own Hot Wheels ® vehicles
    75% stated they would buy Road Play ™
    73% own Lego ®
    73% own Matchbox ® vehicles
    62% own Thomas the Tank Engine ® trains
    58% own toy airplanes
    56% own Hot Wheels ® track or sets
    52% own a cityscape rug
    44% own Thomas the Tank Engine ® wooden track
    35% own a raised play table
    31% own Matchbox ® track or sets
Result: Purchase Intent for Road Play ™ rivals purchase behavior for Hot
Wheels ®, Lego ®, Matchbox ®, & Thomas the Tank
Engine ® vehicles, tracks, & sets.
```

TABLE 3
THE CRITERIA

```
Kid and parent-friendly
    Quick to use and requires little to no assembly
Infinitely flexible
    Highly engaging to the child and promotes creative expression
Realistic
    Allows the child to replicate their world
Inexpensive
    Price-point encourages frequent repeat purchases
Inclusive
    Easily integrates with most major brands of toy cars & building sets
Floor-friendly
    Use on most surfaces without fear of damage
Obvious fit
    Instantly leverages the established toy vehicle market & allows for
    easy display at mass market retailers and specialty toy stores
```

TABLE 4
PRODUCT BENEFITS

```
Instant fun
    Quick and easy to use by adults or children
    Corner connections are instantaneous and foolproof
    Travels anywhere the child goes
    Light, small and easy to carry
    Converts hard-to-roll surfaces into smooth rolling roadways
    Strong graphic appeal has no language barriers
Flexible
    Can be as temporary or semi-permanent as desired
    Allows for frequent changes to any play area
    Can be used anywhere: floors, low-pile carpet, hallways, tabletops,
    highchair trays, grandparent's house, restaurants, businesses
    Works in any size space; is infinitely adaptable
Creative
    Let's children customize their play area in seconds
    Turns rolling a toy vehicle into a more interesting and realistic
    driving adventure
    Frees children from artificial boundaries created by fixed tracks and
    pre-printed play tables and play mats
    Ease of application allows for infinite creative expression
    Allows for creation of realistic or fantasy cityscapes
    Creates infrastructure for integration of most popular building &
    construction toys
    Can be used on walls and furniture to create decorative accents
Safe
    Quick release formula leaves no adhesive residue
    Tears easily; no scissors or sharp implements required
    Non-toxic
Cost-effective
    Costs pennies per foot vs. wooden and plastic alternatives
        Estimated Road Play retail cost = $0.43 per foot
        Estimated wooden track retail cost = $5.08 per foot
        Estimated plastic track retail cost = $3.33 per foot
        Road Play is up to 90% less expensive
```

What is claimed is:

1. Material for creating a play environment for a play figure, comprising:
a non-scar, quick-release adhesive roll of material;
said adhesive selected for substantial adherence to, and for non-scar quick-release from, substrates including domestic flooring, walls and furniture;
wherein portions of said roll of material two-dimensionally simulate structures coordinated to interface with at least one three-dimensional play figure.

2. Play environment equipment, comprising:
three-dimensional toy units;
a two-dimensional structure created with at least one portion of an adhesive roll of material, the structure sized and decorated to coordinate with the three-dimensional toy units; and
the at least one portion substantially adhering to, while providing for non-scar quick-release from, a domestic wall, floor or furniture substrate.

3. A play environment material, comprising:
an adhesive roll of material, portions of which two-dimensionally display structures coordinated with independent toy units, the adhesive selected for non-scar, quick-release from domestic substrate.

4. A method for creating a play environment comprising:
separating at least one portion from a roll of material, the material depicting toy related structure;
adhering the portion to a domestic substrate;
associating the portion with a toy unit;
removing the portion from the domestic substrate without scarring the substrate; and
disposing of the portion.

5. A kit, comprising the material of claims 1 or 3 packed together with at least one toy unit or play figure.
